(19) United States
(12) Patent Application Publication
(10) Pub. No.: US 2025/0167654 A1
(43) Pub. Date: May 22, 2025

(54) ELECTRIC MOTOR AND CORRESPONDING APPLICATION

(71) Applicant: Ziehl-Abegg SE, Künzelsau (DE)

(72) Inventors: Stefan Wesemann, Künzelsau (DE); Roland HOPPENSTEDT, Zweiflingen (DE); Edgar MAYER, Tamm (DE); Uli VETTER, Künzelsau (DE)

(73) Assignee: Ziehl-Abegg SE, Künzelsau (DE)

(21) Appl. No.: 18/841,828

(22) PCT Filed: Feb. 28, 2023
(86) PCT No.: PCT/EP2023/055009

§ 371 Date: Aug. 27, 2024

(30) Foreign Application Priority Data
Feb. 28, 2022 (DE) 10 2022 104 731.8

(51) Int. Cl. H02K 21/14

(52) U.S. Cl. CPC H02K 21/14; H02K 2213/03

(57) ABSTRACT

For an electric motor which has a stator which is set up to generate a rotating magnetic field, and which also has a rotor which is mounted rotatably about a rotation axis and which carries a number of permanent magnets, it is provided, in order to increase the electrical efficiency but also to reduce vibrations during operation, that a stator winding is inserted into slots of the stator and energized with a multiphase current in such a way that the stator forms a magnetic field which is characterized by a number N_{U} of primary areas and that at most five of the slots of the stator are used per primary area. Preferably at least seven, particularly preferably at least eight or even at least ten primary areas can be formable or formed along the circumference of the stator when the stator winding is energized accordingly.

### CROSS-REFERENCE TO RELATED APPLICATIONS

This application is a 371 National Phase of PCT/EP2023/055009, filed Feb. 28, 2023, which claims priority from German Patent Application No. 10 2022 104 731.8, filed Feb. 28, 2022, both of which are incorporated herein by reference as if fully set forth.

### TECHNICAL FIELD

The invention relates to an electric motor, which can be designed in particular as an electric permanent-magnet synchronous machine (PMSM).

### BACKGROUND

This type of electric motor has a stator that forms a number PZ_{S} of magnetic poles of PZ_{S}=2p_{S}, with p_{S} the number of pole pairs of the stator that are formed when a corresponding current is applied. The stator has a number N_{N} of slots for electromagnetically generating the pole pairs. An (electrically energizable) stator winding is inserted into the slots to generate a rotating magnetic field, i.e., the stator winding is set up accordingly to generate the rotating magnetic field. To generate the desired magnetic rotating field, it is sufficient to energize the stator winding with a suitable alternating electric current, while electrical switching operations, such as those used in stepper motors, are not necessary. The electric motor can thus generate a continuous torque in normal operation, i.e., with appropriate continuous current supply with alternating current, so that the electric motor is particularly suitable as a drive motor for an elevator. The magnetic flux generated by energizing the stator winding can be at least partially guided by (in particular tooth-shaped) magnetic flux conductors of the stator.

The electric motor also has a rotor mounted movably about a rotation axis, wherein the rotor, or more precisely a rotor body of the rotor, carries permanent magnets. This rotor can be designed as an internal rotor (e.g., if the electric motor is to be used as a drive for an elevator) or as an external rotor (e.g., if the electric motor is to be used in a fan), depending on the desired application of the electric motor. In both cases, however, it can be characteristic that the permanent magnets are preferably arranged on a (inner or outer) circumference of the rotor/a rotor body of the rotor, i.e., on the circumferential side, so that the rotor carries the permanent magnets on the circumferential side. This can ensure that there is a (particularly very small) air gap between the rotor and stator, between the permanent magnets of the rotor and the stator (and not, for example, between a rotor body and the stator, wherein the rotor body carries the permanent magnets). This naturally has a considerable effect on the generated magnetic field distribution and can distinguish the electric motor, for example, from other electric motors in which permanent magnets are not arranged on the circumferential side but, for example, inside a rotor body of the rotor or axially offset with respect to the rotor body and/or axially offset inwards with respect to an outer circumference of the rotor body, wherein in these designs said air gap typically exists between the rotor body and the stator.

Due to legal requirements, the use of motors with higher efficiencies has become increasingly important in recent years. Corresponding normative agreements define energy-saving classes that have been included in the technical data by the manufacturers.

In order to reduce the significant machine-dependent losses, the current prior art relies on the increased use of copper in the motor winding, better sheet metal material, optimized fan geometry or an energetically optimized bearing. Especially for slow-running motors (e.g., at approximately 300 rpm), either permanent magnet motors with high-pole stator windings (more than 10 magnetic poles in the stator) have often been used, or low-pole (e.g. 2-, 4- or 6-pole) stator windings have been used as 2-hole windings in combination with high-pole rotors (e.g., with a rotor pole count of PZ_{R}>40).

As explained above, the number of pole pairs p is the number of pairs of magnetic poles within rotating electrical machines. An electric motor with three winding strands, each forming two poles, therefore has a pole pair number of p_{S}=1 (there are 2 poles per phase). However, if there are a total of six winding strands in the stator, the electric motor can already have a number of pole pairs of p_{S}=2.

In motors operated directly on the mains, the mains frequency and the number of pole pairs determine the rotating field speed of a rotating field machine. Synchronous machines rotate at exactly the rotating field speed, whereas asynchronous machines rotate at a slightly different speed (depending on the load). The rotating field speed nₛ can be determined as follows: nₛ=f/pₛ, where pₛ is the number of pole pairs and f is the mains frequency.

The mechanical power delivered by the electric motor is then the product of the torque delivered and the speed. For mains-powered motors with the same specified rated power, the rated torque is therefore typically proportional to the number of pole pairs. Motors with the same power but a larger number of pole pairs are therefore generally larger than motors with the same power but a smaller number of pole pairs. However, when comparing motors with the same basic principle and the same size, the achievable nominal torque is not always proportional to the number of pole pairs. Depending on the technology, the torque can increase more or less strongly (but always disproportionately) with an increasing number of pole pairs and can even decrease again when a higher number of pole pairs is exceeded. Accordingly, the number of pole pairs varies considerably in prior-art motors.

In the prior art, windings are inserted into the slots of the stator to form the poles in the stator. The number of pole pairs then results from the winding pattern of the stator windings. A characteristic measure for the winding structure is the number of holes q, which indicates how many slots are available per string m and pole of the stator (given by the pole count PZ_{S}=2p_{S}). The required total number of slots N_{N} in the stator is then calculated as: N_{N}=(PZ_{S} m)/q.

For distributed windings, q≥1. If q is an integer, it is a so-called “whole-hole winding”. On the other hand, reference is made to a fractional hole winding if q is a fractionally rational number. For single-tooth windings, q<1 and is therefore always a fractionally rational number.

### SUMMARY

Against this background, the invention addresses the problem of improving the efficiency of an electric motor as described at the outset. In particular, a high electrical efficiency and a high power factor cos φ is to be achieved (cos φ is also referred to as the active power factor and indicates the ratio of the amount of active power P and apparent power S).

In particular, the invention addresses the specific problem of providing an electric motor which can generate a high torque at speeds of approximately 300 rpm and thereby combines a high electrical efficiency with a preferably high power factor cos φ. The invention thus pursues in particular the aim of providing a high-efficiency motor. A further boundary condition for the invention is the desire to enable such an electric motor to operate as vibration-free as possible, particularly in the speed range of approximately 300 rpm.

To solve this problem, one or more of the features disclosed herein are provided for an electric motor according to the invention. In particular, it is thus proposed according to the invention for solving the problem in an electric motor of the type mentioned at the outset that the stator winding is designed and can be energized in such a way that the following applies to the stator for the ratio of the number N_{N} of its slots and the number N_{U} of the primary areas formed by the stator: (N_{N}/N_{U})<6.

This necessarily gives: N_{N}<(6 N_{U}) or N_{U}>(N_{N}/6). In other words, according to the invention, it can thus be provided that the winding of the coils of the stator is arranged and can be energized in such a way that, in particular in the case of a typical three-phase energization, a sequence of N_{U} similar magnetic primary areas is produced or formed along the circumference of the stator, wherein a maximum of five slots (i.e., less than six slots) should form a respective primary area of the stator. It is particularly preferable here if a maximum of four grooves or even a maximum of only three grooves are used to form a respective primary area (then the following applies: (N_{N}/N_{U})<5 or even (N_{N}/N_{U})<4).

The number of primary areas N_{U} can, for example, be calculated for the respective electric motor as the greatest common divisor (ggT) from the pole count of the rotor PZ_{R} and the number of slots of the stator N_{N}, so that the following applies: N_{U}=ggT(PZ_{R}, N_{N}). Alternatively, the following can also apply: N_{U}=ggT(PZ_{S}, N_{N}) with PZ_{S} the number of magnetic poles that the stator can form (when the stator winding is energized).

A primary area in the sense of the invention can be understood here in particular as a (circular) segment of the stator, which is repeated periodically along the circumference of the stator, specifically in relation to the formation of the magnetic field distribution that results when the stator is energized. The primary areas can thus form a similar symmetry of magnetic poles (in each case in relation to a radial direction) or can form only one respective pole of the stator. Each of said segments can thus show a similar arrangement of the stator winding in order to define a sequence and radial orientation of magnetic poles (or of a magnetic pole) which is repeated in each of the primary areas. Thus, the number PZ_{S} of magnetic poles of the stator can deviate from the number N_{U} of primary areas of the stator, i.e., in particular PZ_{S}>N_{U}. Depending on the design of the stator winding, however, the following can also apply: PZ_{S}=N_{U}.

Preferably, in an electric motor according to the invention, at least seven primary areas can be formed or designed along the circumference of the stator (with corresponding current flowing through the stator winding). In the case of larger motors (for example with an internal stator diameter of more than 200 mm), it can be advantageous to form at least 8 or even at least 10 primary areas along the circumference of the stator (by correspondingly designing the stator winding). Such a high number of primary areas (which, however, also depends on the size of the electric motor and may be correspondingly smaller for smaller diameters of the stator) is favorable in order to achieve a lower amplitude of the mechanical vibrations that occur in the stator, more precisely in the stator yoke (in the case of an internal rotor motor), when the electromagnetically generated poles of the stator interact with those of the rotor (during operation of the motor). This favors low-vibration operation of the electric motor.

A particularly preferred range of values for the design of an electric motor according to the invention can be as follows: Number of poles of the stator PZ_{S}>8, number of slots of the stator N_{N}<50 and number of poles of the rotor PZ_{R}>50.

By designing the electric motor according to the invention, vibration excitation during operation of the motor can be greatly reduced compared to conventional electric motors. As a result, the vibration behavior of the motor (in the sense of reduced excitation of mechanical vibrations) and its environment can be improved, because only very low vibrations emanate from the electric motor during operation and thus low-noise operation of the motor is possible, which is of great advantage especially when used in elevators. The reason for this is the fact that, due to the high number of poles of the stator that is now possible, only very low mechanical vibration excitation occurs when the stator is mechanically loaded in the radial direction by interaction with the permanent magnets of the rotor when energized.

The improvement in vibration damping or reduction in vibration excitation also has the positive side effect that the metal plates typically used for the stator no longer need to be connected with an anchor bolt, as is the case with many previously known motors. As a result, a round cross-sectional shape of the stator laminations can be selected. This offers the advantage that an internally round housing can also be used to enclose an electric motor according to the invention. The connection between the motor and the housing can thus be achieved very easily without screws by means of shrinking, which offers further advantages. Thus, a further problem solved by the invention can be considered that of how the use of previous round motor housings can be maintained without disadvantages in terms of undesirable vibrations and despite an increase in the power factor of the electric motor.

As a result, both a high electrical efficiency and a high power factor can be achieved by the design according to the invention (cf. Table 1). This has advantages for the use of the motor in an electric drive system (for example in fans or elevators), since the frequency converter that may be required to operate the motor (depending on the specific design) can be comparatively small/compact and thus inexpensive, and a high electrical efficiency is also achieved.

An electric motor designed according to the invention can be used particularly advantageously as a slow-running motor with high torque at speeds of approximately 300 rpm, in particular as a so-called torque motor for industrial applications, or for example as a gearless elevator motor in elevators. Use in energy-efficient wheel hub motors or fans is also conceivable and advantageous.

As already mentioned, an electric motor according to the invention can preferably be designed as a permanent-magnet synchronous motor (PMSM), i.e. as an electric permanent-magnet synchronous machine (sometimes also referred to as a “permanently excited synchronous machine”). In particular, the rotor can therefore carry PZ_{R} permanent magnets that form a number PZ_{R} of magnetic poles.

Alternatively or additionally to the features discussed so far, the electric motor described at the outset can also be designed as follows to solve the problem: It can thus be provided, that among other features disclosed herein, the rotor of the electric motor forms a number PZ_{R} of magnetic poles (with the aid of said permanent magnets, i.e., the number PZ_{R} of magnetic poles can in particular correspond to the number of permanent magnets that the rotor carries) and that the following applies for the ratio of the pole count of the rotor PZ_{R} and the pole count PZ_{S} of the stator: PZ_{R}/PZ_{S}≥3. Preferred values are PZ_{R}/PZ_{S}≥5. At the same time, however, it can be advantageous to require at the same time: PZ_{R}/PZ_{S}≤10, i.e. a particularly favorable range of values for the above ratio is: 3≥PZ_{R}/PZ_{S}≤10; preferred values are: 4≥PZ_{R}/PZ_{S}≤8.

The invention has recognized that such a large ratio between PZ_{R} and PZ_{S} is particularly favorable in order to achieve a high electrical efficiency of the electric motor.

In such embodiments, the pole count/number of poles PZ_{R} of the rotor can be formed in particular according to the following law of formation: PZ_{R}=2 N_{N}+/−PZ_{S}. In such a case, the following can therefore apply for the necessary number N_{N} of slots of the stator: N_{N}=(PZ_{R}−/+PZ_{S})/2. Furthermore, according to the invention, in such embodiments the number of slots N_{N} of the stator may preferably be as follows: N_{N}<60 (maximum number of slots of the stator), and preferably additionally: N_{N}≥6 (minimum number of slots of the stator). A particularly preferred value range for the number N_{N} of stator slots is: 50≥N_{N}≥12.

Alternatively or in addition to the features discussed so far, the electric motor described at the outset can also be designed as follows to solve the problem: It can thus be provided, that among other features disclosed herein, the rotor of the electric motor has a maximum outer diameter D_{Ra} and forms a number PZ_{R} of magnetic poles, wherein a permanent magnet is arranged in each case within a pole width B_{PR} of the rotor of B_{PR}=2πD_{Ra}/PZ_{R}. This pole width can therefore be understood as a circumferential portion along the outer circumference 2πD_{Ra} of the rotor, within which one permanent magnet on average is arranged.

Furthermore, magnetic flux conductors of the stator, which delimit the slots, can be designed in the form of teeth. The teeth can form a tooth width B_{Z} at their base, which defines a respective slot width B_{N} of the slots for holding the stator winding. Furthermore, it may be provided that a slot is formed between adjacent teeth of the stator with a slot width B_{S} and that the following applies to the ratio of tooth width B_{Z} to pole width B_{PR} (24): B_{Z}/B_{PR}>0.4 or B_{Z}>(0.4 B_{PR}). In this case, it is particularly advantageous if the following also applies for the ratio of slot width B_{S} and tooth width B_{Z}: B_{S}/B_{Z}>1.0, i.e., B_{S}>B_{Z}. The invention has recognized that such dimensioning of the stator offers considerable advantages in order to improve the product of efficiency and power factor cos φ of the electric motor.

This approach can be described qualitatively in such a way that the width of the teeth B_{Z} should be selected as a function of the pole width B_{PR} of the rotor, but so wide that only slightly more than two tooth widths already make up one pole width. It is particularly preferable if the following applies: B_{Z}>(0.5 B_{PR}). In this case, a maximum of two tooth widths add up to a given pole width of the rotor. The teeth should therefore be comparatively wide compared to previously known electric motors. On the other hand, the tooth width should not be excessive. Therefore, in embodiments according to the invention, it can also be provided that the following additionally applies for the ratio of the tooth width B_{Z} of the teeth of the stator and the pole width B_{PR} of the rotor (cf. the above definition): B_{Z}/B_{PR}<0.7.

In addition, the slots, or more precisely the slot width B_{S}, between the teeth of the stator, can also be designed to be comparatively wide, i.e., open. However, there are also limits to this opening, meaning that the ratio of slot width B_{S} and tooth width B_{S} can also be used: B_{S}/B_{Z}>1.2, i.e., the slot width B_{S} can preferably be 20% greater than the width of the respective tooth at its base.

In further possible embodiments of the invention, the following may also apply: B_{S}/B_{Z}>1.3; preferably B_{S}/B_{Z}>1.4; particularly preferably B_{S}/B_{Z}>1.5.

Possible embodiments of the invention can provide, for example: B_{S}>5 mm, preferably: B_{S}>10 mm, particularly preferably: B_{S}>11 mm. For a given inner diameter of the stator of D_{SI}, it is therefore advantageous if the ratio of slot width and D_{SI} (i.e., B_{S}/D_{SI}) is at least 3.0%, preferably at least 3.5%. For larger motors with inner diameters of more than 350 mm, however, this ratio can also fall to values of less than 2.5%.

It can also be provided that the following applies for the ratio of the useful slot width B_{S} and the outer diameter of the stator D_{Sa}:B_{S}/D_{Sa}>2%, preferably B_{S}/D_{Sa}>2.5%. At the same time, however, it is advantageous if values of B_{S}/D_{Sa}=0.34 are not exceeded. Thus, there is a preferred value range for the useful slot width B_{S} of: 2%<B_{S}/D_{Sa}<3.4% as a function of the outer diameter of the stator. This applies to both external rotor and internal rotor motors.

The value ranges described above with reference to the design of the slots and teeth of the stator make it possible to form a high number of magnetic poles of the stator PZ_{S} even in a confined installation space. For example, the following can apply to a motor according to the invention: PZ_{S}≥12, in particular with an internal stator diameter of less than 250 mm.

The aforementioned tooth-shaped magnetic flux conductors of the stator can preferably be designed in one piece with a stator yoke of the stator and/or can be made of a ferromagnetic material. These are also crucial in the formation of the magnetic primary area.

According to the invention, the problem can also be solved by further advantageous embodiments according to the description and claims that follow.

The concepts of the invention presented so far for dimensioning electric motors can be applied both to motors in which the magnetic flux runs in a radial direction and thus perpendicular to a rotation axis of the motor, or in an axial direction along the rotation axis. In other words, an electric motor according to the invention can thus be designed as an axial flux motor, in particular in the form of a disk rotor motor, or as a radial flux motor or even as a combination of an axial flux motor and a radial flux motor.

Furthermore, the rotor of the electric motor can be designed as an internal rotor or as an external rotor. If the rotor is designed as an internal rotor, the rotor preferably carries the permanent magnets on the outer circumference; if the rotor is designed as an external rotor, on the other hand, it carries them on the inner circumference. In both cases, an (especially very small) air gap can be formed between the respective permanent magnet and the stator.

As already mentioned, it can be advantageous, particularly for low-vibration operation of the electric motor, if at least seven, preferably at least ten, primary areas can be formed or are formed along the circumference of the stator. In the case of very small motors, however, a number of two primary areas may also be sufficient. The decisive factor is primarily the ratio of the number N_{N} of slots in the stator and the number N_{U} of primary areas.

According to a further advantageous embodiment, the ratio of the number of poles of the rotor PZ_{R} and the number of poles of the stator PZ_{S} can apply: PZ_{R}/PZ_{S}≤10 (then the following applies: PZ_{R}≤10 PZ_{S}), in particular PZ_{R}/PZ_{S}≤8 or even PZ_{R}/PZ_{S}≤5. The invention thus proposes limiting the number of poles/permanent magnets of the rotor to at most a factor of ten, or even a factor of eight or even a factor of five (as in the examples according to Table 2), depending on the number of poles of the stator PZ_{S}. If the number N_{U} of primary areas of the stator should also be N_{U}≥7 and the stator winding is designed so that only one magnetic pole is formed per primary area (so that PZ_{S}=N_{U}≥7), this can, for example, lead to values of electric motors according to the invention as shown in Table 2.

TABLE 2
Design parameters of three electric motors of
different sizes according to the invention

| | | | |
|---|---|---|---|
| Stator inner | 240 | 310 | 430 |
| diameter D_{Si} [mm] | | | |
| Rotor pole count PZ_{R} | 60 | 80 | 100 |
| Stator pole count PZ_{S} | 12 | 16 | 20 |
| Number of primary areas N_{U} | 12 | 16 | 20 |
| PZ_{R}/PZ_{S} | 5 | 5 | 5 |
| D_{Si} [mm]/PZ_{R} | 4.0 | 3.9 | 4.3 |

In electric motor embodiments according to the invention, however, a certain minimum number of poles of the rotor should still be maintained in order to ensure good synchronization of the electric motor. For this reason, the following can preferably also be provided for the electric motor: PZ_{R}/PZ_{S}≥4, and particularly preferably PZ_{R}/PZ_{S}≥5.

In further possible embodiments of the invention, the following may also apply: PZ_{R}/PZ_{S}≤8, preferably PZ_{R}/PZ_{S}≤6, particularly preferably PZ_{R}/PZ_{S}≤5, for example as in the above examples of Table 2.

In other words, the stator pole count PZ_{S}=2p_{S} can be selected to be comparatively high compared to previously known motors, for example with PZ_{S}≥8, preferably PZ_{S}≥10, particularly preferably PZ_{S}≥12, in particular PZ_{S}≥16. A particularly preferred range of values for the stator pole count PZ_{S} is: 12≥PZ_{S}≥20.

However, as already explained, the pole count PZ_{R}=2p_{R} of the rotor can also be selected to be (comparatively) high, for example with PZ_{R}≥40, preferably PZ_{R}≥50 or even PZ_{R}≥60 (cf., for example, the examples in Table 2). In individual cases, the rotor pole count can therefore be 60, 80 or even 100 (cf. Table 2), depending on the size of the motor, wherein the number of poles will naturally tend to increase as the size of the motor increases. As there is typically only a very small air gap between the rotor (designed either as an external or internal rotor) and the stator, an advantageous dimensioning for an internal rotor, for example, can be that a permanent magnet of the rotor is arranged at least every 5 mm along the inner circumference of the stator, so that the following applies: D_{Si}/PZ_{R}≤5.0 mm; preferably: D_{Si}/PZ_{R}≤4.5 mm.

The teeth of the stator can preferably be T-shaped, in particular in such a way that the tooth width B_{Z} is smaller than a respective tooth tip width B_{ZK} of the respective tooth. It is also helpful if the teeth are oriented strictly radially to the rotation axis.

Said teeth of the stator can thus form a tooth tip width B_{ZK} on their radial inner side. The ratio of slot width B_{S} and tooth tip width B_{ZK} can then preferably be as follows: B_{S}/B_{ZK}>0.45. In this case, the respective slot width therefore occupies a circumferential length that corresponds to more than 45% of the tooth tip width (which can also be measured along the circumference). In further possible embodiments of the invention, the following can also apply: B_{S}/B_{ZK}>1.05; preferably B_{S}/B_{ZK}>1.10; particularly preferably B_{S}/B_{ZK}>1.20. In other words, the slot width can be much greater than is usual with conventional electric motors.

The technical effect achieved by such open slots is that a high power factor cos φ and simultaneously low electrical losses can be achieved for an electric motor with a stator pole count PZ_{S} and rotor pole count PZ_{R} that are not equal (as proposed here in particular). For motors with the same stator and rotor count (PZ_{S}=PZ_{R}), however, the use of such open slots is rather disadvantageous, especially for the power factor cos φ. Closed slots should therefore be used for such motors wherever possible.

The stator of an electric motor according to the invention can have fewer than two teeth per pole of the rotor. This means that the following can apply to the number ZZₛ of teeth on the stator: ZZₛ<2 PZ_{R}. In particular, the following can also apply: N_{N}<2 PZ_{R}.

For the ratio of a minimum inner diameter D_{Si} of the stator and a maximum outer diameter D_{Sa} of the stator, the invention proposes a dimensioning that complies with the following specification: D_{Si}/D_{Sa}≥0.80. For an internal rotor, this means that in this case the rotor has an installation space available that is approximately 80% of the outer diameter of the stator (at least if the minimum necessary air gap between the rotating rotor and stator is ignored). This provides a large cross-sectional area (for a given maximum size of the electric motor) (this increases quadratically with the radius) through which the magnetic flux can be conducted, allowing larger torques to be generated.

The stator winding of the electric motor can be designed in different ways. For the number of holes q of the electric motor, defined as q=N_{N}/(2p_{S} m) with N_{N} the number of slots of the stator, 2p_{S}=PZ_{S} the number of magnetic poles of the stator and m the number of phases or strands of the stator winding, it is preferable if: q<1.5; preferably q=1, because then a comparatively short winding head length can be achieved, which offers advantages in terms of simple production of the electric motor. In other words, the concept according to the invention can be realized particularly well with a single-hole winding. In other words, the number of holes q can preferably be an integer.

The number of slots N_{N} of the stator can preferably be an integer multiple of the number of pole pairs p_{S} of the stator. This is because in this case a fractional-hole winding, which is expensive to manufacture, can be avoided and the stator winding can instead be realized as a whole-hole winding. For the same reason, it is advantageous if the number N_{N} of slots does not exceed a value of 60, preferably 50.

A magnet width B_{M} of a respective one of the permanent magnets of the rotor can be defined, for example, as a circular arc B_{M}=Q2πD_{Ra}/N_{M}, which is occupied by one of the permanent magnets, with D_{Ra} the maximum outer diameter of the rotor, Q the circumferential portion occupied by the respective permanent magnet and N_{M} the number of permanent magnets of the rotor (3), wherein typically N_{M}=PZ_{R}. Based on this definition, embodiments according to the invention are preferred for which the following applies: B_{M}<20 mm, preferably: B_{M}<15 mm. Furthermore, it may additionally be provided that the following applies: B_{M}≥10 mm, particularly preferably: B_{M}≥11 mm. These value ranges make it possible to form a sufficient number of rotor poles and at the same time comply with the limitations with regard to the number of stator poles required.

As already mentioned, the rotor of the electric motor can form a number PZ_{R} of magnetic poles with the aid of its permanent magnets. If the stator has an outer circumference of U_{S}=2πD_{Sa}, preferred embodiments of electric motors according to the invention are as follows: 25 mm<U_{S}/PZ_{R}<75 mm, particularly preferably: 28 mm<U_{S}/PZ_{R}<50 mm; these values thus indicate the respective circumferential length on the outer circumference of the stator, within which a magnet of the rotor is to be arranged in each case.

As has already been mentioned several times, the stator winding can have a plurality, in particular a number m, of strands or phases, or m different electrical phases can be formed with the m strands when the strands are energized accordingly. The electric motor can therefore preferably have a frequency converter with which the stator winding can be supplied with electrical voltage. In particular, the stator can have a three-phase/three-strand stator winding (m=3). In this case, the number of stator pole pairs p_{S} can be a multiple of three; however, other configurations are also possible.

The permanent magnets of the rotor can preferably be electrically insulated from a rotor body of the rotor.

Furthermore, a respective flux direction of the permanent magnets of the rotor can also be oriented radially in relation to the rotation axis of the rotor.

A relative angular position of the magnetic poles of the rotor can have an angular offset in the circumferential direction within a first axial segment of the rotor (in comparison) to a relative angular position of magnetic poles within a second axial segment of the rotor.

Alternatively or additionally, a relative angular position of the magnetic poles of the stator in the circumferential direction within a first axial segment of the stator (in comparison) to a relative angular position of magnetic poles within a second axial segment of the stator may also have an angular offset.

In particular, such angular offsets can be designed in such a way that the poles of the rotor/stator are formed in a continuous slope along the rotation axis. Alternatively, such a configuration of an electric motor according to the invention can also provide for the poles of the rotor to be arranged in a stepped incline, similar to steps, along the rotation axis. The rotor can also be continuously inclined. Alternatively or additionally, such a stepped or continuous inclination of the poles can also be provided on the stator.

In particular, the invention proposes that an electric motor according to the invention is dimensioned and supplied with an electrical operating voltage in such a way that during operation in a speed range of approximately 300 rpm a maximum stator frequency of f_{S,max}=200 Hz, preferably of f_{S,max}=150 Hz is not exceeded. The stator frequency indicates the frequency at which the laminations forming the stator are remagnetized during motor operation, while the speed of the motor indicates the frequency at which the rotor rotates. It is particularly preferable if the electric motor is used in such a way that the stator frequency does not fall below a minimum of f_{S,min}=20 Hz, preferably f_{S,min}=15 Hz, during operation.

Such targeted use of an electric motor according to the invention makes it possible to operate the electric motor optimally in a speed range of approximately 300 rpm, i.e. with high efficiency and with acceptable heat generation due to the low-frequency remagnetization. This is of interest for numerous applications, in particular for driving elevators, where this speed range must be provided frequently and repeatedly by the electric motor. In a configuration as described above, electric motors according to the invention can therefore be used particularly effectively and efficiently in the speed range of approximately 300 rpm.

### BRIEF DESCRIPTION OF THE DRAWINGS

The invention will now be described in more detail with reference to exemplary embodiments, but is not limited to these exemplary embodiments. Further embodiments of the invention can be obtained from the following description of a preferred exemplary embodiment in conjunction with the general description, the claims and the drawings.

The following description of examples serves only to explain design variables, in particular the primary areas of the stator, which can be designed in accordance with the invention; possible design variables by which a motor in accordance with the invention can be characterized are shown in the following list. The electric motors shown in the figures thus do not yet show a design according to the invention; however, electric motor designs according to the invention are easily accessible to a person skilled in the art with the aid of the figures by applying the rules described above and in the claims for numerous design variables of the stator and/or the rotor. In the drawings, elements which correspond in their function are also given corresponding reference numerals even if their design or shaping differs.

In the drawings:

FIG. 1 shows a highly simplified schematic cross-section of a conventional electric motor,

FIG. 2 shows a further view analogous to that of FIG. 1 of another electric motor,

FIG. 3 shows a further view analogous to that of FIG. 1 of another electric motor,

FIG. 4 shows a detailed view of the electric motor from FIG. 3, wherein only one quadrant is shown.

### DETAILED DESCRIPTION

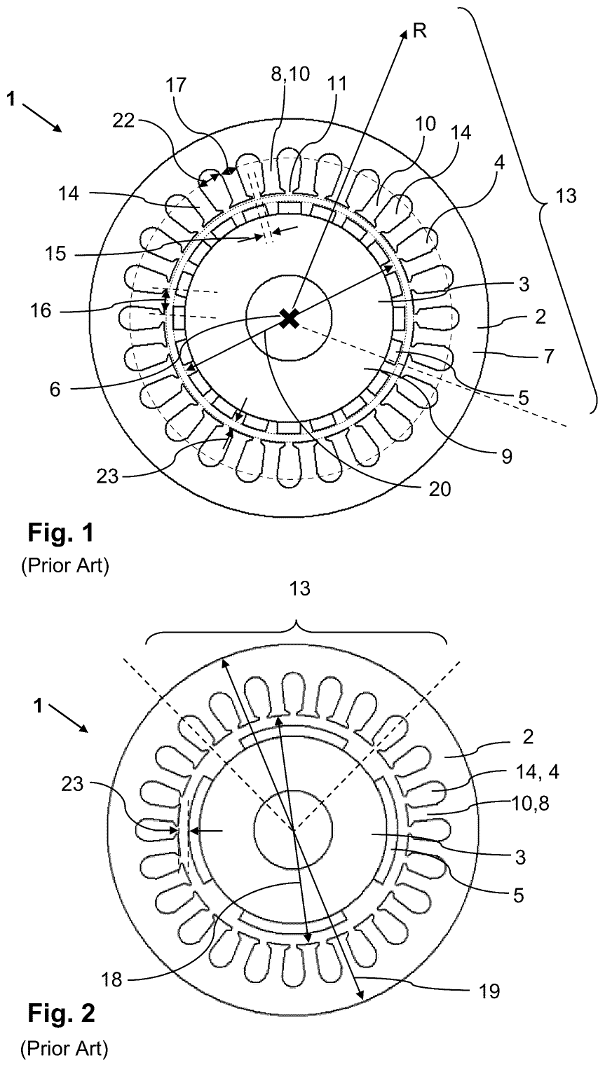

FIG. 1 shows a highly simplified schematic cross-section of an electric motor 1 as known in the prior art. The electric motor 1 has a stator 2 and a rotor 3 designed as an internal rotor and carrying a total of twenty permanent magnets 5, wherein the rotor 3 is mounted rotatably about the rotation axis 6 shown. In other words, the rotor 3 thus has a number of magnetic poles PZ_{R}=20, which corresponds to the number of its permanent magnets 5 (wherein each of the permanent magnets 5 forms a north/south pole pair).

It can be seen in all figures that the permanent magnets 5 are arranged on the circumferential side, namely on the outer circumference of the respective internal rotor 3. Accordingly, the minimum air gap 23 (see FIG. 1), which the magnetic flux must pass through, is also formed between the respective permanent magnet 5 and the respective tooth 10 of the stator 2. If the concept according to the invention is transferred to an external rotor motor, this would also apply, except that the permanent magnets 5 would then be placed on the inner circumference of the external rotor (which is on the outside in relation to the stator), so that the permanent magnets 5 would again be aligned with the stator teeth 10.

The stator 2 has a total of N_{N}=24 grooves 14. The grooves 14 are formed by the spaces that exist between the magnetic flux conductors 8 of the stator 2, which are designed as teeth 10. A stator winding 4 (not illustrated), which has three strands (m=3), is inserted into the total of twenty-four slots 14.

When the stator winding 4 is energized accordingly, the stator 2 of FIG. 1 can generate a rotating magnetic field, wherein the stator 2 forms a number PZ_{S} of magnetic poles for this purpose, and wherein the following applies: PZ_{S}=2p_{S} with p_{S} the number of pole pairs of the stator 2. When the stator winding is energized with alternating electric current, the rotor 3 can thus be set in rotation without any electrical switching processes, because the stator winding 4 then generates a rotating magnetic field that pulls the rotor 3 along. As a result, a continuous torque can be generated with the electric motor 1 during normal operation.

In the example shown in FIG. 1, the stator 2 forms two pairs of poles per strand and therefore a total of four poles per strand, so that the following applies for the pole count: PZ_{S}=12, as m=3 strands are used in the stator winding 4. This means that two slots 14 of the total of twenty-four slots form a magnetic pole of the stator 2. This results in a sequence of a total of four primary areas 13, each of which shows a similar sequence of three poles of the stator 2 (one pole per strand and primary area 13). Each of the four primary areas 13 is formed by a total of six grooves 14 (5 whole grooves plus two half grooves each on the left and right edges of the primary area 13), which thus occupy the circular segment of the stator 2 illustrated in FIG. 1. The aforementioned sequence of three magnetic poles is repeated periodically along the circumference of the stator 2 in each of the four primary areas 13, wherein each of the four primary areas 13 not only has the same number of poles (namely three), but also shows a similar symmetry of the magnetic field distribution in relation to the radial axis R. As a result, it is sufficient, for example, to simulate the field distribution in one of the primary areas 13 in order to be able to calculate the entire field distribution generated by the stator 2.

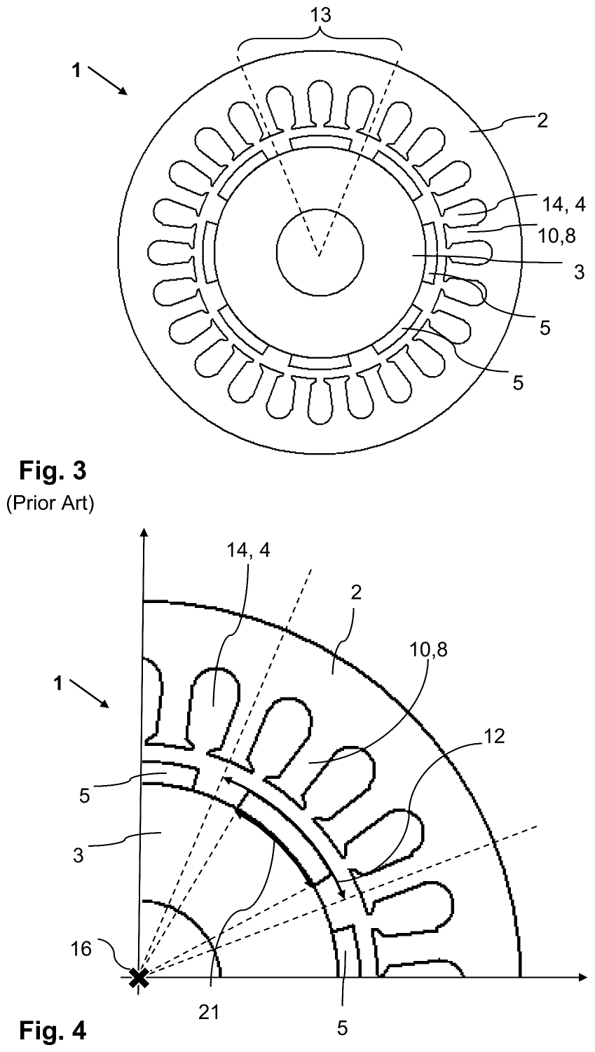

FIGS. 2 and 3 show further examples of previously known electric motors 1, wherein the respective stator 2 can form four primary areas 13 (FIG. 2) or eight primary areas 13 (FIG. 3) when the stator winding 4 is energized accordingly. In the case of FIG. 3, four teeth 10 with the four associated slots 14, or the stator winding 4 inserted therein (with corresponding current flow), each form a primary area 13.

FIG. 4 shows a detailed view of a quadrant of the electric motor 1 illustrated in FIG. 3. It can be seen that the permanent magnets 5 of the rotor 3 are arranged evenly as usual along the outer circumference of the rotor 3, which is designed as an internal rotor. Each permanent magnet 5, which has a magnet width 21 (measured as an arc length on the surface of the rotor body), occupies a pole width 12 of B_{PR}=2 πD_{Ra}/PZ_{R} with D_{Ra} the outer diameter 20 of the rotor 3 (see FIG. 1) and PZ_{R} the number of magnetic poles of the rotor 3. Here, each of the permanent magnets 5 forms one pole of the rotor 3, so that the number of poles PZ_{R} of the rotor 3 is equal to the number of permanent magnets 5 of the rotor 3 (in the case of FIG. 3, PZ_{R}=8).

Further design variables relevant to the invention are shown in FIGS. 1 and 2, namely the outer diameter 19 of the stator 2 D_{Sa}, the inner diameter 18 of the stator 2 D_{SI}, the air gap 23 existing between stator 2 and rotor 3, the outer diameter 20 of the rotor 3 D_{Ra}, the slot width 15 B_{S}, the slot width B_{N} 22, the tooth tip width 16 B_{ZK}, and the tooth width B_{Z} 17 of the T-shaped teeth 10. As indicated by the dashed and dotted circles in FIG. 1, these values can each be measured along circumferential lines. The tooth width B_{Z} 17 can, for example, be measured at the base of the respective tooth 10, for example at the point of the largest groove width 22 B_{N} of a groove 14.

Based on these illustrations, embodiments of electric motors according to the invention, as previously described and in particular described in the claims, can now be reproduced comparatively easily. For example, an electric motor 1 according to the invention can be designed as shown in Table 1, for example with a rotor 3 that has a pole count of PZ_{R}=60, a stator 2 that forms a total of PZ_{S}=12 poles and an equal number N_{U} of twelve primary areas 13 (so that a primary area 13 then defines only a single magnetic pole in each case and the following applies: N_{U}=12), resulting in a ratio of PZ_{R}/PZ_{S}=5. For this purpose, N_{N}=36 slots 14 can be provided on the stator 2.

Maintaining this principle, the pole count 3 of the rotor can then be increased to PZ_{R}=80 for larger sizes, for example. In this case, while retaining PZ_{R}/PZ_{S}=5, the pole count of the stator 2 can be PZ_{S}=16, wherein in this case sixteen primary areas 13 and N_{N}=48 slots are provided on stator 2.

For an even larger design of an electric motor 1 according to the invention, the following can apply, for example: PZ_{R}=100; PZ_{R}/PZ_{S}=5; PZ_{S}=20=N_{U}; N_{N}=60.

Further possible embodiments of electric motors 1 according to the invention are described in the claims, wherein the respective design parameters can be understood with reference to FIGS. 1 to 4 (for illustrative purposes only). By following the dimensioning of the stator 2 proposed by the invention and the design of the magnetic rotating field generated by the stator 2, both low-vibration and highly efficient operation of the electric motor 1 can be ensured. The approaches presented here for designing a high-efficiency electric motor 1 can be applied to motors with internal or external rotor 3. For this purpose, only the design parameters described must be observed.

To summarize, for an electric motor 1 which has a stator 2 which is set up to generate a rotating magnetic rotating field, and which also has a rotor 3 which is mounted rotatably about a rotation axis 6 and which carries a number of permanent magnets 5, it is proposed, in order to increase the electrical efficiency but also to reduce mechanical vibrations during operation, that a stator winding 4 is inserted into slots 14 of the stator 2 and is energized with a multiphase current in such a way that the stator 2 forms a magnetic field which is characterized by a number N_{U} of primary areas 13 and that at most five of the slots 14 of the stator 2 are used per primary area 13. Here, preferably at least seven, particularly preferably at least eight or even at least ten primary areas 13 can be formable or formed along the circumference of the stator 2 when the stator winding 4 is energized accordingly.

### LIST OF REFERENCE SIGNS

1 electric motor
2 stator
3 rotor
4 stator winding
5 permanent magnet (of 3)
6 rotation axis
7 stator yoke
8 magnetic flux conductor (of 2)
9 magnetic flux conductor (of 3)
10 tooth (of 2)
11 slot (between 8/10)
12 pole width (e.g., outer circumferential length of 3, within which a permanent magnet is arranged)
13 primary area
14 slot (of 2)
15 slot width Bₛ (width of 11)
16 (stator) tooth tip width B_{zk} (width of 10 at the tip end (radially inside))
17 (stator) tooth width B_{z} (width of 10, outside the tip region at the base)
18 stator inner diameter (inner diameter of 2)
19 stator outer diameter (outer diameter of 2)
20 rotor outer diameter (outer diameter of 3)
21 magnet width (arc length of 5)
22 groove width B_{N} (width of 14)
23 air gap (between 2 and 3)

### Design Parameters Used

PZ_{S}=2p_{S}=number of magnetic poles of the stator
p_{S}=number of pole pairs of the stator
PZ_{R}=pole count of the rotor
p_{R}=number of pole pairs of the rotor
N_{N}=number of slots of the stator
N_{U}=number of primary areas of the stator
B_{PR}=2 πD_{Ra}/PZ_{R}=pole width of the rotor
D_{Ra}=outer diameter of the rotor
B_{N}=slot width of the stator slots
B_{Z}=tooth width
B_{S}=slot width
B_{ZK}=tooth tip width
ZZₛ=number of teeth of the stator
D_{Si}=inner diameter of the stator
D_{Sa}=outer diameter of the stator
q=N_{N}/(2p_{S} m)=number of holes
m=number of (current) phases or strands used in the stator winding
B_{M}=Q2πD_{Ra}/N_{M}=magnet width of each of the permanent magnets of the rotor
Q=the proportion of the circumference occupied by the permanent magnets (in %)
N_{M}=number of permanent magnets of the rotor
U_{S}=2πD_{Sa}=outer circumference of the stator

1. An electric motor (1), comprising:
a stator (2) which forms a number PZ_{S} of magnetic poles of PZ_{S}=2pₛ, with pₛ being a number of pole pairs of the stator (2);
the stator (2) has a number N_{N} of Slots (14) in which a stator winding (4) is arranged, which is set up to generate a rotating magnetic field;
a rotor (3), which is mounted movably about a rotation axis (6) and which carries permanent magnets (5) on a circumferential side thereof;
the rotor (3) forms a number PZ_{R} of magnetic poles which corresponds to a number of the permanent magnets (5); and
for a ratio of the number of magnetic poles PZ_{R} of the rotor and the number of magnetic poles PZ_{S} of the stator, the following applies: PZ_{R}/PZ_{S}≥3.

2. The electric motor (1) as claimed in claim 1, wherein PZ_{R}/PZ_{S}≤10.

3. An electric motor (1) comprising:
a stator (2) which forms a number PZ_{S} of magnetic poles of PZ_{S}=2pₛ, with pₛ being a number of pole pairs of the stator (2);
the stator (2) has a number N_{N} of slots (14) in which a stator winding (4) is arranged, which is set up to generate a rotating magnetic field;
a rotor (3), which is mounted movably about a rotation axis (6) and which carries permanent magnets (5) on a circumferential side thereof; and
the stator winding (4) is designed and is energizable in such a way that for the stator (2) for a ratio of the number N_{N} of the slots (14) and a number N_{U} of primary areas (13): N_{N}/N_{U}<6.

4. An electric motor (1) comprising:
a stator (2) which forms a number PZ_{S} of magnetic poles of PZ_{S}=2pₛ, with pₛ being a number of pole pairs of the stator (2);
the stator (2) has a number N_{N} of slots (14) in which a stator winding (4) is arranged, which is set up to generate a rotating magnetic field;
a rotor (3), which is mounted movably about a rotation axis (6) and which carries permanent magnets (5) on a circumferential side thereof;
the rotor (3) has a maximum outer diameter (19) D_{Ra} and forms a number PZ_{R} of magnetic poles;
a permanent magnet (5) is arranged within a pole width (24) B_{PR} of the rotor (3) of B_{PR}=2πD_{Ra}/PZ_{R} in each case;
magnetic flux conductors (8) of the stator (2), which delimit the slots (14), are designed as teeth (10), wherein the teeth (10) form a tooth width B_{Z} (17) at respective bases thereof, which defines a respective slot width B_{N} (22) of the slots (14) for accommodating the stator winding (4);
a slot (11) with a slot width B_{S} (15) is formed between adjacent ones of the teeth (10);
for the for a ratio of the tooth width B_{Z} (17) to the pole width B_{PR} (24): B_{Z}>(0.4 B_{PR}); and
for a ratio of the slot width B_{S} (15) and the tooth width B_{Z} (17): B_{S}>B_{Z}.

5. The electric motor (1) as claimed in claim 1,
wherein the electric motor (1) is designed
as an axial flux motor,
a radial flux motor,
a combination of an axial flux motor and a radial flux motor
and/or wherein the rotor (3)
is designed as an internal rotor and carries the permanent magnets (5) on an outer circumference or
as an external rotor and carries the permanent magnets (5) on an inner circumference.

6. The electric motor (1) as claimed in claim 3,
wherein at least seven base regions (13) are formable or formed along a circumference of the stator (2).

7. The electric motor (1) as claimed in claim 1,
wherein PZ_{R}/PZ_{S}≤10 and
PZ_{R}/PZ_{S}≥4.

8. The electric motor (1) as claimed in claim 1,
wherein the pole count PZ_{S}=2pₛ of the stator (2) is selected to be high, with PZ_{S}≥8.

9. The electric motor (1) as claimed in claim 1,
wherein the pole count PZ_{R}=²p_{R} of the rotor (3) is selected to be high, with PZ_{R}≥40.

10. The electric motor (1) as claimed in claim 4,
wherein B_{Z}/B_{PR}<0.7 and
B_{S}/B_{Z}≥1.2.

11. The electric motor (1) as claimed in claim 4, wherein the teeth (10) of the stator (2)
are at least one of T-shaped or
oriented radially to the rotation axis (6).

12. The electric motor (1) as claimed in claim 4,
wherein the teeth (10) of the stator (2) form a tooth tip width B_{ZK} (16) on a radial inner side, and
for a ratio of the slot width B_{S} (15) and the tooth tip width B_{ZK} (16): B_{S}/B_{ZK}>0.45.

13. The electric motor (1) as claimed in claim 4, wherein less than two of the teeth (10) per pole of the rotor (3) are formed on the stator (2), so that for a number ZZ_{S} of teeth (10) on the stator (2): ZZ_{S}<2 PZ_{R}.

14. The electric motor (1) as claimed in claim 1,
wherein for a ratio of a minimum inner diameter (18) D_{Si} of the stator (2) and a maximum outer diameter (19) D_{Sa} of the stator (2): D_{Si}/D_{Sa}≥0.8.

15. The electric motor (1) as claimed in claim 4,
wherein a number of holes q of the electric motor (1) is defined as q=N_{N}/(2p_{S} m) where 2p_{S}=PZ_{S} the number of magnetic poles of the stator (2) and m is a number of phases or strands of the stator winding (4), and
for the number of holes q: q<1.5.

16. The electric motor (1) as claimed in claim 1,
wherein the number of the slots N_{N} is an integer multiple of the number of the pole pairs p_{S} of the stator (2).

17. The electric motor (1) as claimed in claim 1,
wherein a magnet width B_{M} (21) of a respective one of the permanent magnets (5) of the rotor (3) is defined as a circular arc B_{M}=Q2πD_{Ra}/N_{M}, which is occupied by one of the permanent magnets (5), with
D_{Ra} being a maximum outer diameter (19) of the rotor (3),
Q beinq a circumferential portion occupied by the permanent magnets (5) and
N_{M} being a number of permanent magnets (5) of the rotor (3),
and wherein: B_{M}<20 mm.

18. The electric motor (1) as claimed in claim 1,
the stator (2) has an outer circumference of U_{S}=2πD_{Sa} (19) and
wherein: 25 mm<U_{S}/PZ_{R}<75 mm.

19. The electric motor (1) as claimed in claim 1,
wherein at least one of: a) the stator winding (4) has a plurality of strands or phases,
b) the electric motor (1) further comprises a frequency converter with which the stator winding (4) is adapted to be supplied with electrical voltage, or
c) the stator (2) has a three-phase stator winding (4).

20. The electric motor (1) as claimed in claim 1,
wherein at least one of the permanent magnets (5) of the rotor (3) are electrically insulated from a rotor body (6) of the rotor (3), or
a respective flux direction of the permanent magnets (5) of the rotor (3) is oriented radially with respect to the rotation axis (6) of the rotor.

21. The electric motor (1) as claimed in claim 1,
wherein a relative angular position of the magnetic poles of the rotor (3) in the circumferential direction within a first axial segment of the rotor (3) has an angular offset relative to a relative angular position of magnetic poles within a second axial segment of the rotor (3).

22. The electric motor (1) as claimed in claim 1
the electric motor (1) is dimensioned and supplied with an electrical operating voltage such that a maximum stator frequency of f_{S,max}=200 Hz is not exceeded during operation.
